(19) United States
(12) Patent Application Publication
(10) Pub. No.: US 2009/0199606 A1
(43) Pub. Date: Aug. 13, 2009

(54) TAMPER EVIDENT SEAL

(76) Inventors: Yoram Gil, Hod Hasharon (IL); Yoram Tsivion, Pardes Hanna (IL)

Correspondence Address: YORAM TSIVION, P.O. BOX 1307, PARDES HANNA, 37111, IL

(21) Appl. No.: 12/027,289

(22) Filed: Feb. 7, 2008

(51) Int. Cl. G09F 3/00

(52) U.S. Cl. 70/440

(57) ABSTRACT

A security sealing system providing tamper detection. Including a self locking flexible material strip bearing indicia and an electronic system. The electronic system includes at least a transponder, having two separated subunits. The transponder is accessible when intact by a wireless reader means, indicating the intactness of said transponder and reading the transponder's memory.

### FIELD OF THE INVENTION

The present invention is in the field of security, property protection and anti theft control.

### BACKGROUND OF THE INVENTION

Potential unlawful breaking into packages, parcels or containers shipped by mail or delivered by transportation firms or by mail, while in the process of being shipped or while stored in store rooms and other property storage facilities is a prime consideration in the facilitation of stock and material supply and transportation. Various types of locking and alarm means are employed for preventing intrusion or at least the notification regarding an intrusion.

Marine, air and ground transportation involves in many cases the use of standard containers. A container or a package departing from the port of origin is locked and an identifiable seal is placed via the door handles or around the container or the package such that breaking into the container through the door or to the package through the cover becomes evident by the rupture of the seal. The identity of the seal is recorded prior to departing from the port of origin, and the container or parcel, once reaching the destination port is checked for the condition of the seal. Its identity is recorded and compared to the one recorded at the port of origin. A ruptured seal may be presumed as indicative of unlawful breaking into the container or the package.

Most popular seal today is an identifiable plastic seal. The plastic strip bears indicia, typically embossed on the strip, which is a unique number that can be visualized and recorded by personnel at inspection posts. Presently, in order to find out if the seal is tampered and further to record the unique indicia one must examine the seal at a very close range, typically, between 20 to 50 cm while the seal is motionless.

The worldwide increase in traffic of containers and packages call for automation and increased reliability of all steps hitherto considered as bottlenecks in the procedures associated with transportation. Specifically, the present invention focuses on enabling expedited reading and recording of seals. Particularly verifying seal indicia and finding out evidence for tampering, while the package or the container is in motion and from a distance of for example 4 meters and at a cost which is close to the present price of a simple plastic seal as described above.

### DESCRIPTION OF THE DRAWINGS

FIG. 1A is a schematic isometric description of a tamper evident seal in an unfolded state;

FIG. 1B is a schematic isometric description of a tamper evident seal showing encased electronic subsystems;

FIG. 2A is a schematic diagram describing a strap type seal in a locked position;

FIG. 2B is a schematic diagram describing a cable-tie type seal in a locked position;

FIG. 2C is a schematic diagram describing a broad strap type seal in a locked position

FIG. 3 is a block diagram of the main modules of the transponder of the system of the invention.

### DETAILED DESCRIPTION OF THE PRESENT INVENTION

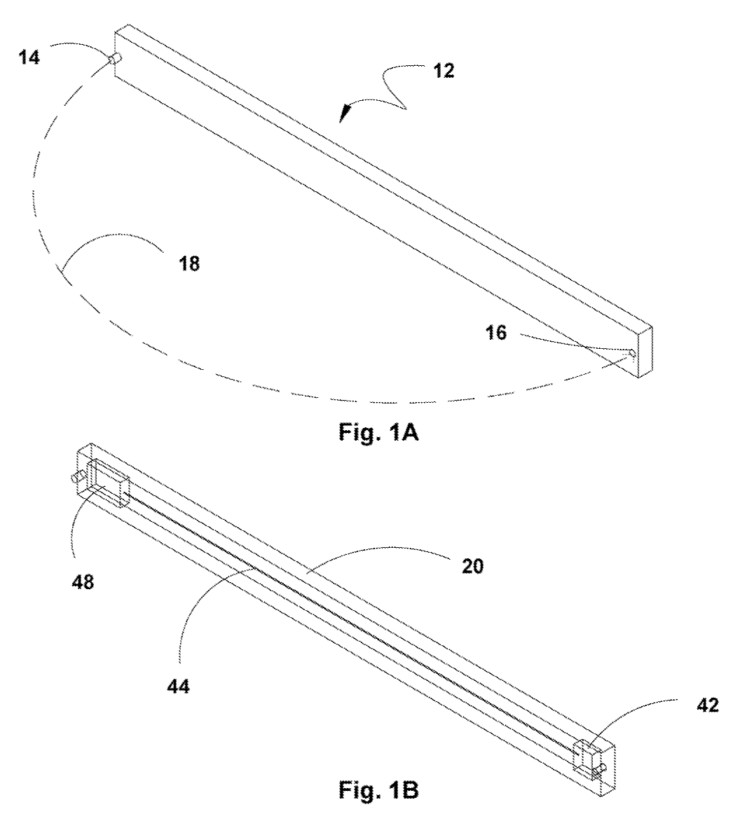

A system in accordance with the present invention is implemented in an identifiable flexible (plastic or other material) seal. The seal of the invention has two general aspects, the structural aspect, and the electronic aspect. An exemplary seal of the invention contains an electronic device described schematically in FIGS. 1A-1B to which reference is first made. Tamper evident seal (TES) 12 is an oblong object, flexible enough to permit some convolution such as for inserting in an aperture in a container's handle or coiling around a construction element of a safe receptacle. Pin 14 protruding from TES 12 reaches a matching recess 16 into which it is forcibly pushed, as TES 12 is bent or convoluted along arrow 18, forming a stable connection between the two ends of TES 12. Pin 14 and the matching recess are formed such that the insertion is unreleasable, and the opening up of the connected pin and recess association is only possible by cutting. The seal of the invention is self locking, meaning that the seal parts can form a tight union that cannot open unless the seal is broken. The closing mechanism described above is exemplary and many other irreversible closing/locking mechanisms, as known in the art, are applicable in order to achieve the mutual locking of both ends of the TES. Preferably, in order to untie the junction formed by locking the TES, it must be torn. In a preferred embodiment of the invention, the plastic strip bears indicia, a unique number that can be recognized typically visually and recorded by personnel at inspection posts.

The electronic aspect of the TES in one embodiment is further explained with reference to FIG. 1B. Plastic strip 20 contains an electronic system made up of several electronic subsystems. Subsystem 42, embedded within the strip includes a power source, typically thin batteries, feeding subsystem 48 of the TES through conducting line 44.

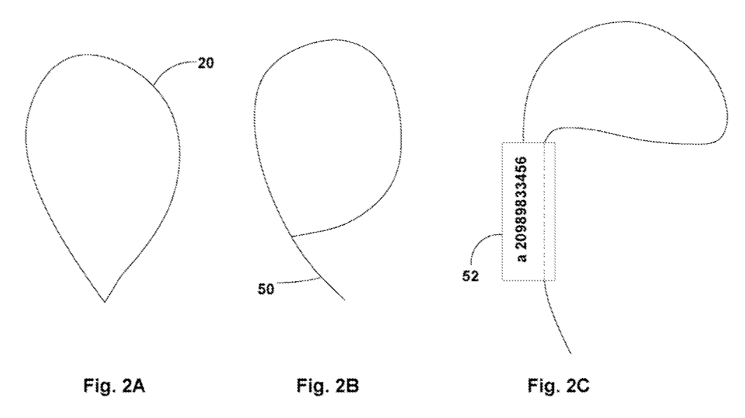

When the plastic strip is bent or convoluted for sealing an access port to a storage facility such as a box or a container, a firm connection is to be formed between one end of the strip and another location on the strip. A few possibilities are shown schematically in FIGS. 2A-2C to which reference is now made. In FIG. 2A plastic strip 20 is folded such that both ends are joined together at a joint, as inferred by the description of the drawing above. In FIG. 2B, a cable tie type seal is used as a strip, such that a certain portion 50 of the strip is left free. In FIG. 2C a different kind of seal is used in which a plate 52 is used for both identity inscription and for locking the end of the strips. In each case, the evidence for tampering is both visible, i.e. tearing of the strip or connection, and loss of electronic response to a reader. In a preferred embodiment, a galvanic connection is effective at the junction, so that tearing apart the junction as such would cause a breach of the functionality of the electronic aspect of the TES.

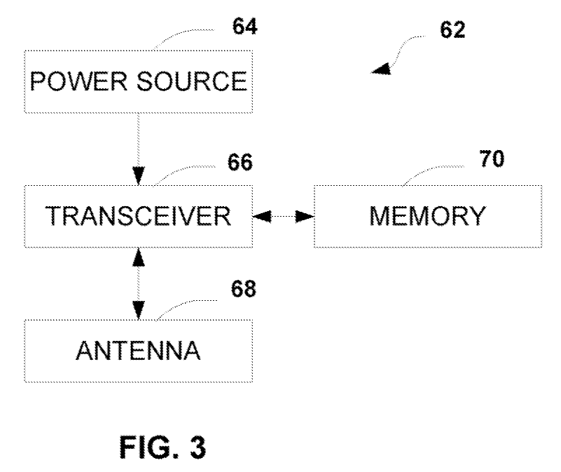

The main electronic modules of the system of the invention are described schematically in FIG. 3 to which reference is now made. Electronic system 62, embedded generally within the plastic strip described above, includes as follows: power source 64 that energizes transceiver 66. The transceiver in this case includes means for retrieving memory and typically also means for modulating/demodulating signals. Signals are sent and received through antenna 68, and an ID number which corresponds with the indicia embossed on the TES is stored in memory 70. A wireles reader, not shown, is an active electronic apparatus employing a transmitter that interrogates the TES either when in motion or in a motionless state. In more detail, a signal coming from the reader is received by the TES and invokes a response which subsequently sends an ID number stored in memory 70.

In another embodiment of the present invention, the electronic assemblage of the TES does not contain an energy source and the entire energy for reading the memory and for resending a signal to the reader is obtained from the reader itself. In such a case, the antenna of the TES not only receives an interrogation signal, but also receives energizing power.

As a matter of convenience and convention, the transceiver, its antenna and memory and power source, if required, can be referred to as transponder.

It should be noted that the electronic features of the TES, either active or passive types, are not necessarily unique and may be obtained in the market from various producers of transponders, typically RFID (RF identification) tag producers.

Energy Source for the TES

Thin batteries such as paper thin batteries, ultra thin batteries are applicable, or any such battery as can be preferably totally embedded in the TES plastic. The battery need not be a rechargeable type.

For passive type transponder embodiments, no battery is needed.

Creation of Electric Discontinuity

If not responded to, the reader when employed to read the contents of the TES memory, may assume that the electric wholeness of the TES has been breached. Referring to FIG. 2, any breach of the connection between the modules can cause a complete failure of the electronic system. Thus, antenna to transceiver connection, transceiver to power source and transceiver to memory connection failures, can each cause a non response to the wireless reader. More physically, as can be seen in FIG. 1B, line 44 is a line feeding power from power source in subsystem 42 to subsystem 48. In one embodiment subsystem 48 includes memory, transceiver and antenna, but other effective arrangements are possible. Any arrangement by which any tamper causes a breach of the electric circuits in the TES is applicable. Thus subsystem 48 may contain a combination of batteries and memory, while subsystem 42 is to contain the transceiver and the antenna. To make the vulnerability of the TES to mechanical breach as extensive as possible, any cut made in the TES is to fail the electronic system. Thus cutting the TES in the location of the batteries, RFID, antenna or mechanical locking. In yet another aspect of the invention, condutors of electricity notably such as spanning the length of the TES are made of easily oxidizable metal. Thus the metal conductor conducting between the batteries and the RFID, such as element 44 in FIG. 1B, is made of an oxidizable metal. Some common metals, specifically sodium, potassium, calcium or to a lesser extent magnesium, are such metals that would oxidize upon exposure to oxygen in the air, a phenomenon which renders metals non conducting when exposed to the air.

Benefits of the Invention

The present invention suggests a reasonable non expensive solution to some bottlenecks in the transportation of containers and packages. It facilitates reading and verifying and recording seals identity and validating their intactness, identifying tamper, from a distance while the sealed object may be in motion. The transponder system used in the system of the invention may be a purchased from a variety of transponder makers, for example makers of anti theft transponders, together with a matching reader.

1. A security sealing system providing tamper detection, said system comprising:
a self locking flexible material strip bearing indicia;
an electronic system encased in said strip, said electronic system including at least a transponder, forming at least two separated subunits;
wherein said transponder is accessible when intact by a wireless reader means, indicating the intactness of said transponder and reading the transponder memory.

2. A security sealing system providing tamper detection as in claim 1 wherein said self connecting flexible material is a plastic material.

3. A method for validating the intactness of a security seal associated with a transponder comprising the steps of:
interrogating said security seal by using a transponder reader within a prescribed distance from said transponder;
receiving a response from said transponder;
interpreting said reception as a validation of intactness, and
recording an ID number associated with said seal.

4. A security sealing system providing tamper detection as in claim 1, wherein at least a part of the electric conductors of which is made of easily oxydisable metal.
